(19) United States
(12) Patent Application Publication
(10) Pub. No.: US 2025/0296558 A1
(43) Pub. Date: Sep. 25, 2025

(54) ENHANCED SITUATIONAL AWARENESS OF ROAD OBJECTS

(71) Applicant: Janice H. Nickel, Pacifica, CA (US)

(72) Inventor: Janice H. Nickel, Pacifica, CA (US)

(21) Appl. No.: 18/611,457

(22) Filed: Mar. 20, 2024

(51) Int. Cl. B60W 30/095; B60W 50/00

(52) U.S. Cl. CPC B60W 30/0956; B60W 50/0097

(57) ABSTRACT

A plurality of motor vehicles are used as network edge devices, including receiving data structures from the motor vehicles as the motor vehicles are on a road system. Each data structure includes a timestamp, at least one identification of a nearby road object, and a position of each identification. A plurality of positions for each identification are aggregated over time such that each identification has a corresponding time series. For each identification, a trajectory is predicted from the corresponding time series.

### BACKGROUND

In general, situational awareness refers to the perception of elements in an environment within a volume of time and space, the comprehension of the meaning of the elements, and the projection of their status in the near future. In the particular case of automobiles and other road vehicles that are equipped with computer vision systems, object detection algorithms and advanced cameras and sensors are employed to analyze surroundings in real-time and recognize elements such as pedestrians, road signs, barriers, and other vehicles. With respect to a mobile object, perception, comprehension and projection may be achieved while that mobile object is within the field of view of a computer vision system and sufficient data has been collected to identify the object and evaluate its movement.

### BRIEF DESCRIPTION OF THE DRAWINGS

FIG. 1 is an illustration of certain features of a server system for providing enhanced situational awareness of road objects on a road system.

FIGS. 2A and 2B are illustrations of an example of a data structure received by the server system of FIG. 1.

FIG. 3 is an illustration of an example of clusters of positions reported by multiple vehicles over a given area of a road system.

FIG. 4 is an illustration of an example of trajectory prediction on statistical models of the clusters of FIG. 3.

FIG. 5 is an illustration of a decision tree illustrating different levels of classification of different road objects.

FIG. 6 is an illustration of logic for predicting a trajectory of a road object.

FIGS. 7A and 7B are illustrations of certain features of methods for providing enhanced situational awareness of road objects on a road system.

FIG. 8 is an illustration of a method of generating artificial intelligence (AI) models for different classifications.

FIG. 9 is an illustration of a road system partitioned into multiple zones, and a server system including a core server and client servers assigned to the zones.

FIG. 10 is an illustration of certain features of a server that is configured to provide enhanced situational awareness of road objects on a road system.

FIG. 11 is an illustration of a first motor vehicle equipped with camera vision and a second motor vehicle equipped with multiple RF readers for determining an identification and position of a road object on a road system.

### DETAILED DESCRIPTION

By virtue of the concepts discussed herein, enhanced situational awareness of road objects on a road system is provided. In general, a road system may be characterized as a system of interconnecting streets or roads for a given area. A road system may be classified by type or function, such as unpaved roads, conventional single lane roads, undivided two-way roads, divided roads, expressways, and freeways. Road systems are designed to facilitate the movement of people and goods by various modes of transportation.

As used herein, a road system may have one or more functions that cover a given area. For example, a road system covering a given area may include a freeway, and divided and undivided roads.

As used herein, the language “on a road system” refers to occupying a road system. A road system may be occupied by traveling along a road system, fixed to a road system, standing on road system, parked on a road system, etc.

The language “on a road system” also refers to being proximate to a road system. For purposes herein, a road object fixed alongside a road system is on the road system.

There may be fixed (immobile) road objects on a road system. Examples of fixed road objects include, but are not limited to, road markers (e.g., raised pavement markers, guard rails, impact barrels, and runaway truck ramp markers), traffic control devices other than road markers (e.g., medians, curbs, handicap access ramps, traffic lights, speed limit signs, yield signs, street identification signs, freeway entrance signs, and exit signs), bus shelters, crosswalks, gates, and public utility objects (e.g., fire hydrants, power poles, telephone poles, and light posts).

At any given time, there may be mobile road objects on the road system. Examples of mobile road objects include pedestrians (both adult and minor), pets, service animals, human powered and electric-assisted vehicles (e.g., bicycles, skateboards, scooters), mobility assistive devices (e.g., canes, walkers, strollers, and wheelchairs), and small, low mass items such as drones (e.g., delivery robots).

Additional examples of mobile road objects include motor vehicles. Examples of motor vehicles include motorcycles, automobiles, trucks, and buses.

At least some of the motor vehicles are configured to gather information about nearby road objects while on a road system. The information includes identifications of nearby road objects. The information further includes relative positions of the nearby road objects with respect to the motor vehicles and/or absolute positions with respect to the road system. “Nearby” is relative to the motor vehicle gathering the information, and indicates the object is within the range of the information gathering capability.

Motor vehicles having different configurations may be used to gather information about nearby road objects. A first configuration of a motor vehicle may identify nearby objects with a computer vision system, including a camera, object detection algorithm and distance sensors such as LIDAR or RADAR to detect objects within a field of view, classify the objects, and determine relative positions of the objects with respect to the motor vehicle.

A second configuration of a motor vehicle may identify nearby objects with a computer vision system including a camera and object detection algorithm, but without distance sensors. The camera may use parallax or other algorithms to determine the position of a nearby object relative to the motor vehicle.

A third configuration of a motor vehicle may identify nearby objects and determine their relative positions as described in Nickel et al. U.S. Pat. No. 11,036,239. In the '239 patent, fixed and mobile road objects carry RF devices, which generate and broadcast wireless identification signals (in response to interrogator signals where the RF devices are passive). Encoded in a wireless identification signal is an identification of the road object carrying the RF device. For example, a person may carry an RF device (for instance, in a shoe, a backpack, purse or belt) that broadcasts a wireless identification signal identifying the person as a person. A bicycle may carry an RF device that broadcasts a wireless identification signal identifying the bicycle as a bicycle. Fixed infrastructure such as a stop sign may carry an RF device that broadcasts a wireless identification signal identifying the stop sign as a stop sign.

The third configuration includes an RF receiver configured to receive wireless identification signals from nearby objects. For each wireless identification signal, the receiver reads the identification of the nearby object associated with that signal and uses characteristics of the wireless identification signal to determine a relative position of the nearby object.

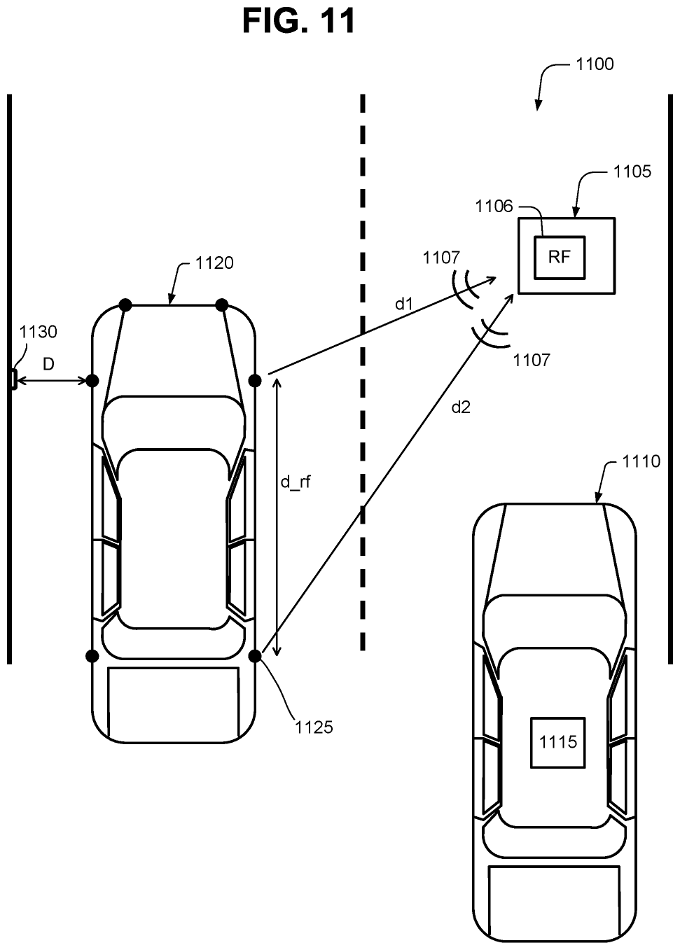

Reference is made to FIG. 11, which illustrates a road system 1100, a mobile road object 1105 on the road system 1100, and first and second motor vehicles 1110 and 1120 traveling in the same direction on the road system 1100. The first motor vehicle 1110 is configured with a camera vision system 1115 including at least one camera, object detection algorithm and distance sensors. When the road object 1105 comes into detection range of the first motor vehicle 1110 (that is, becomes a nearby object), the camera and the algorithm identify the road object 1105 and the sensors determine a time series of relative positions of the road object 1115 with respect to the first motor vehicle 1110.

The second motor vehicle 1120 is configured with multiple RF interrogators/readers 1125 and a processor that can determine the position of the road object 1105 relative to the second motor vehicle 1120. The readers 1125 generate RF interrogation signals, which cause an RF device 1106 carried by the road object 1105 to broadcast wireless identification signals 1107. Analysis of a wireless identification signal 1107 may be performed with the two RF readers 1125 on the near side of the second motor vehicle 1120. Since those two RF readers 1125 are at different locations, there will be a time difference between receipt of the wireless identification signal 1107; and similarly there will be a difference in the signal strength. Either difference may be used to determine relative distances d1 and d2 to the road object 1105. The processor may determine the relative distances d1 and d2 from strength of signal (“SoS”), time of flight (“ToF”) or time of arrival (“ToA”) of the wireless signal 1107. Knowing these distances d1 and d2, and also knowing distance d_rf between the two near-side readers 1125, the processor may then triangulate the relative position of the road object 1105. A time series of relative positions is generated with repeated measurements as the second motor vehicle 1120 approaches the road object 1105.

A motor vehicle that is aware of its absolute position on the road system 1100 may convert the time series of relative positions of the road object 1105 to a time series of absolute positions of the road object 1105 on the road system 1100. For example, at a given time t, the absolute position at time t is added to the relative position at time t.

The first motor vehicle 1110 may determine its absolute position via the Global Positioning System (GPS) or a more precise positioning system such as the Military Grid Reference System (MGRS).

The second motor vehicle 1120 may determine its absolute position by utilizing an infrastructure in which fixed road objects (e.g., a street light, lamp post, stop sign) and traffic control devices such as raised pavement markers 1130 carry passive or active RF devices that transmit wireless signals. Absolute position of a fixed road object is encoded in its wireless signal. For instance, a raised pavement marker 1130 transmits a directional wireless signal indicating its absolute position. The RF readers 1125 of the second motor vehicle 1120 are further configured to receive the directional wireless signal, read the absolute position of the raised pavement marker 1130, determine its relative distance D to the raised pavement marker 1130 (for example, by using SoS), and then determine its own absolute position.

The absolute position of a fixed road object may be encoded into an RF device using GPS coordinates or coordinates from a more accurate position system (e.g., MGRS). A precise position of a fixed road object may instead be determined by other means (e.g., via land surveying), and that precise location may be printed onto and transmitted by the RF device.

As used herein, the term “absolute position” includes uncertainty in the position from informational sources (e.g., GPS or RF enabled road marker) and measurement processes (e.g., ToF or SoS or ToA).

The second motor vehicle 1120 may be configured to compute additional information. In FIG. 11, each distance d1 and d2 represents the length of a vector from the location of a reader 1125 to the location of the RF device 1106 carried by the road object 1105. The readers 1125 that receive the wireless identification signal 1107 may not be at the front or back of the second motor vehicle 1120, and the RF device 1106 is not necessarily at the front or back of the road object 1105. Additional processing may be performed to determine the distances between, say, the front of the second motor vehicle 1120 and the back of the road object 1105. The positions of the readers 1125 and the RF device 1106 may be established by a standard per the type of road object (wheel wells for motor vehicles, mid-center for small bodies, etc.). The second motor vehicle 1120 may store its physical dimensions. The second motor vehicle 1120 may look up the physical dimensions of the road object 1105 after identifying it. In addition, the road object 1105 may encode its physical dimensions in the wireless identification signal 1107 as well as the location of the RF device on the road object 1105. For example, a bicycle may identify itself as a bicycle, and also give the length and width of the bicycle and the location of the RF device, or it may provide a code that correlates to this information, or it may provide a code corresponding to the location of this information in a lookup table. Given the distances d1, d2 and d_rf and the physical dimensions, the processor can compute the distance between the front of the second motor vehicle 1120 and the back of the road object 1105.

The second motor vehicle 1120 may be further configured to determine uncertainty of its measurement capability. For instance, the second motor vehicle 1120 may use the reported absolute location of the fixed road object (e.g., raised pavement marker) 1130 and compare it an absolute location measured by the vehicle, for instance by ToF and/or ToA, and calculate the difference in the known position and calculated position to determine the uncertainty in the vehicle's calculation of the fixed road object 1130.

The second motor vehicle 1120 may be further configured to calculate additional information pertaining to the wireless signals. If the second motor vehicle 1120 generates an interrogation signal periodically, and a fixed road object 1130 responds to each interrogation signal, then the time between each relative position in the time series is known. Knowing this delta time and the velocity of the vehicle, the velocity of the road object 1105 may be computed as the difference in its position divided by the delta time. In the alternative, the velocity of the road object 1105 may be computed as the difference in its absolute position divided by the delta time.

Similarly, object accelerations may be calculated from the difference in velocity divided by the time difference between measurements. Changes in velocity may include changes in speed as well as changes in direction.

The first motor vehicle 1110 may be configured to determine additional information from images captured by its camera(s). For example, in instances where there are multiple road objects 1105 of the same type, other discriminating information may be determined to distinguish one road object from the other. Consider the example of several bicycles in a group. Captured image data may be used to distinguish the bicycles. For instance, the bicycles might be distinguished by color or by color of clothes worn by the riders (e.g., a red jacket for one, a green jacket for another).

A motor vehicle that is autonomous may use the information that it collects to navigate a road system. Different classifications of autonomous road vehicles may use the information about a nearby road object, including the identification, relative positions and calculated velocities and accelerations in different ways. An autonomous motor vehicle having an NHTSA level 0 classification has no automation, but it may use the identifications, relative positions and calculated velocities to issue warnings (e.g., sound an audible alarm when a nearby road object is within an unsafe distance). An autonomous motor vehicle having a level 1 classification may also use the identifications, relative positions and calculated velocities for specific automation (e.g., assistance with braking to avoid collisions). An autonomous motor vehicle having a level 2 classification may use the identifications, and relative positions and calculated velocities for combined function automation (e.g. using at least two primary control functions to work in unison to relieve the driver of control of those functions). An autonomous motor vehicle having a level 3 classification may use the identifications, relative positions and calculated velocities for limited self-driving automation, wherein a driver can fully cede control of all safety-critical functions in certain conditions (e.g., sense when conditions require the driver to retake control and provide a “sufficiently comfortable transition time” for the driver to do so.

An autonomous motor vehicle having a level 4 classification may use the identifications, relative positions and calculated velocities for full self-driving (FSD) automation. For example, an autonomous motor vehicle having a level 4 classification may use the identifications, relative positions and calculated velocities and other encoded information not only to avoid obstacles, but also to plot and execute a navigation path.

At all levels, changes in velocity may be used to generate alerts about nearby road objects that are exhibiting unsafe or unpredictable behavior. For example, nearby road objects having frequent changes in speed might suggest a driver who is distracted by activities such as looking at a cell phone, eating, or applying makeup. Frequent small changes in direction might indicate vehicle drift and might suggest possible intoxication, Large changes in direction might indicate a vehicle weaving between road lanes in an unsafe manner.

However, the use of such information alone by a motor vehicle configured with camera vision is limited only to nearby objects within the field of view of that motor vehicle. Moreover, the field of view can be diminished by conditions such as fog, rain or snow. Additionally, the field of view may be occluded by other road objects (e.g., parked cars), decorative objects (e.g., bushes), or infrastructure elements (e.g., bus stops). The use of such information alone by a motor vehicle configured to decode and measure RF signals is limited by the range of RF communication.

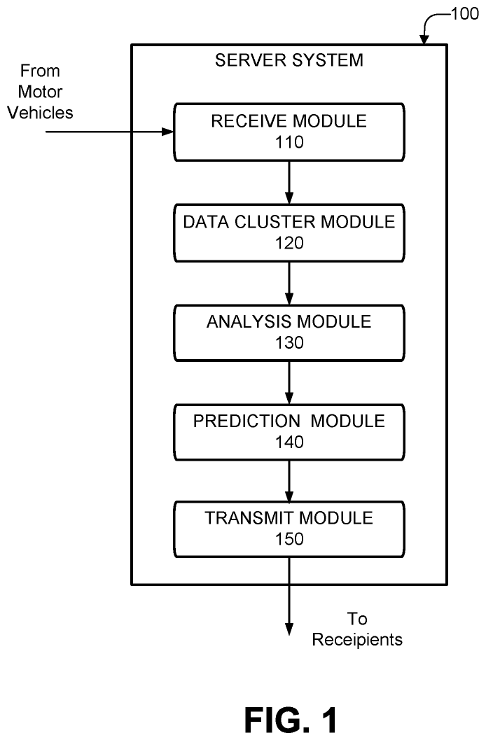

Reference is made to FIG. 1, which illustrates certain features of a server system 100 that addresses these issues by providing enhanced situational awareness to users of a road system. The server system 100 of FIG. 1 is illustrated and described in terms of functionality. Certain structural features of the server system 100 will be described below.

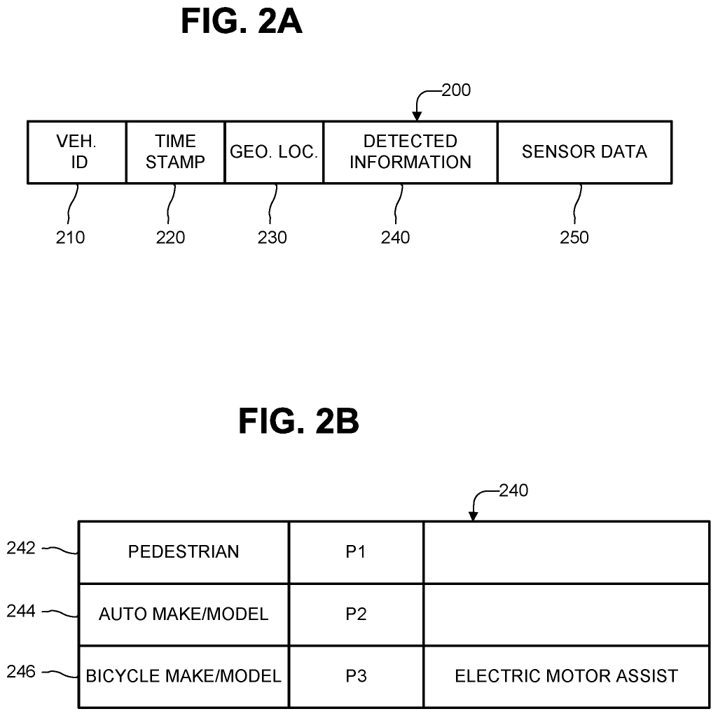

The server system 100 includes a receive module 110 that is configured to receive data structures from a plurality of motor vehicles on a road system. An example of a data structure 200 sent by a motor vehicle is illustrated in FIG. 2A. The data structure 200 includes a field 210 for vehicle identification, a field 220 for a time stamp, a field 230 for geographic location, and a detected information field 240 for relaying information detected or calculated by the motor vehicle.

The vehicle identification provides an identification of the motor vehicle sending the data structure 200. The identification may include, for example, a last few digits of a vehicle identification number.

The time stamp indicates the time when the information in the information field 240 was detected. The time stamp enables the server system 100 to correlate that detected information with information detected by other motor vehicles. Without this correlation, lag times for data upload could complicate computations performed by the server system 100.

The time stamp also allows data to be preserved when there is interruption in wireless services. If a motor vehicle is temporarily disconnected from wireless communication, it can store the data structures 200 locally and transmit the data structures 200 when the wireless communication is re-established.

The time stamp may also enable the server system 100 to differentiate between behaviors of road objects based on time of day. For example, the time stamp may be used to determine lighting conditions (dawn, daytime, dusk, or nighttime). Certain road objects might behave differently in different lighting conditions.

The geographic location enables the server system 100 to differentiate behaviors of specific road objects by location. For example, a bicycle messenger in a downtown area of a major city will behave differently than a cyclist taking a ride in a rural area.

The detected information may include at least an identification and position of each road object detected by the motor vehicle. An identified road object (the “identification”) may have a simple classification (e.g., a pedestrian) or it may have a more detailed classification (e.g., a child pedestrian). A detailed classification of a motor vehicle such as make and model enables details of the motor vehicle to be ascertained (e.g., vehicle type, size, weight, horsepower, braking and handling capability).

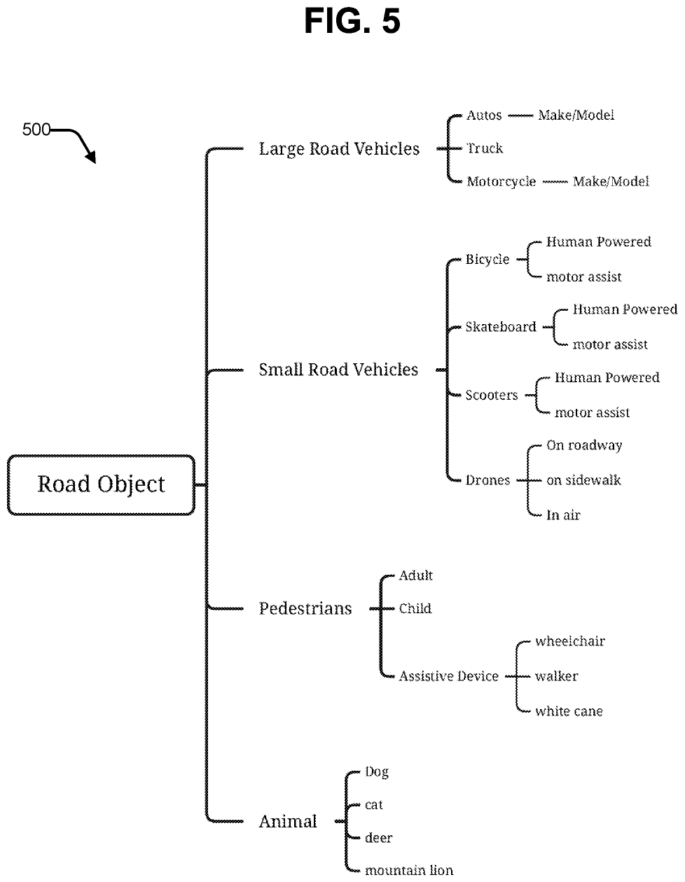

FIG. 5 illustrates an example of different levels of classification 500 for different types of road objects. In this example, the most general level of classification is an unclassified road object. That is, a motor vehicle merely detects the presence of road object.

At the next level, the motor vehicle classifies the road object as animal, pedestrian, small road vehicle, or large road vehicle. The animal may be further classified as a dog, cat, deer or mountain lion.

The pedestrian may be further classified as an adult, child, or pedestrian having an assistive device. The assistive device may be further classified as a wheelchair, walker, or white cane.

The small road vehicle may be classified as a bicycle, skateboard, scooter or drone. The bicycle, skateboard, and scooter may be further classified as human-powered or motor-assisted. The drone may be further classified as to whether it operates in the air, on a roadway, or on a sidewalk.

The large road vehicle may be classified as an automobile, truck, or motorcycle. These vehicles may be further classified by make and model.

The identification in the detected information field 240 may be represented by a code that corresponds to a location in a lookup table which indicates the identification of the object. For example, code “001” may indicate a “pedestrian”, code “002” may indicate a detailed identification of a “pedestrian: child.”

The position in the detected information field 240 may be an absolute position, but could instead be a relative position. If the data structure 200 includes a relative position, the receive module 110 can determine the absolute position of the motor vehicle sending the data structure 200, and combine the absolute position with the relative position of the identification.

FIG. 2B illustrates an example of three entries 242-246 in the detected information field 240. The entries 242-246 indicate that three nearby road objects were detected by a motor vehicle. A first entry 242 identifies a pedestrian at a relative position P1. A second entry 244 identifies an automobile at a relative position P2. The identification of the automobile is detailed as it identifies make and model. A third entry 246 identifies a bicycle at position P3. The identification of the bicycle is detailed as it identifies make and model. The third entry 246 also indicates additional detail in that the bicycle make and model has electric motor assist. The identification and detailed information in the entries 242 and 246 are worded as for clarity, as this information may be encoded for conserving memory space and reducing lag time. A lookup table with corresponding entries may be used to identify the road object and the detailed information.

If the motor vehicle computes the uncertainty of its detected positions (as discussed above), the uncertainty of the vehicle's measurement capability may also be added to the data structure 200.

The data structure 200 may contain an additional field 250 for data from sensors of the motor vehicle that sends the data structure 200. The sensor data might include data about water on windshields, speed of wipers; ambient temperature, whether and which lights are on (normal, high beams, fog lights); whether anti-skid is enabled; etc. The server system 100 may use the sensor data to infer the behavior of nearby road objects. A motor vehicle may upload the sensor data intermittently rather than uploading it in every data structure 200.

While on a road system, and while connected to a wireless communication system, a motor vehicle will continuously generate and transmit data structures such as the data structure 200 of FIG. 2A. As illustrated in the example of FIG. 2B, each data structure may include identifications and positions of multiple road objects. Moreover, on a busy road, more than one motor vehicle will be detecting the same road objects. The receive module 110 receives all of these data structures.

The server system 100 includes a data cluster module 120 that is configured to create a time series of clusters for each identification that is reported by multiple motor vehicles. Each cluster includes the positions of an identification within a time slot. Multiple motor vehicles may make multiple observations of the same road object at substantially the same time.

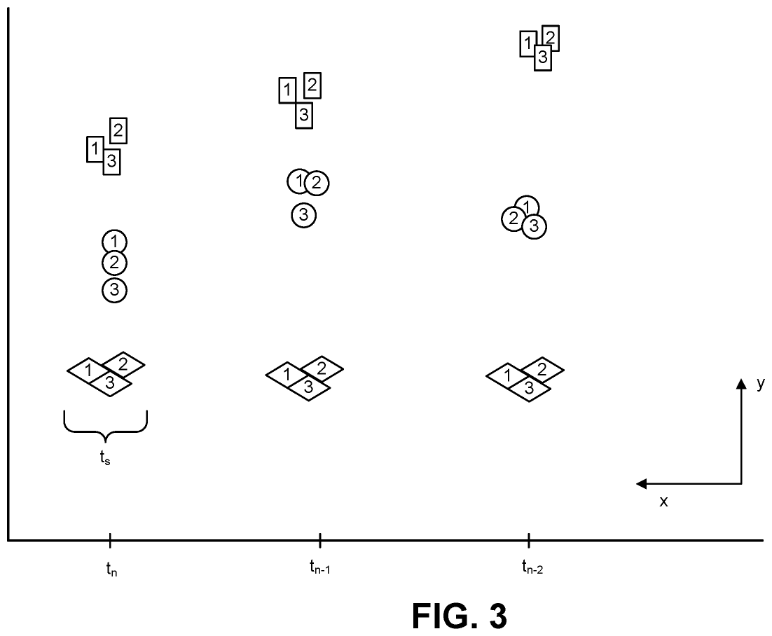

Additional reference is made to FIG. 3, which illustrates a simple example of a plot of object identifications, absolute positions and time that were reported in data structures received from three different motor vehicles 1, 2 and 3. Each reported absolute position contains inherent error. The reported information in each data structure included entries for a first identification, a second identification, and a third identification. Reported positions are clustered at time slots, which are centered about times tₙ, tₙ₋₁, tₙ₋₂, where to is the most recent time slot. In the plot of FIG. 3, the reported positions of the first identification are represented by squares, the reported positions of the second identification are represented by circles, and the reported positions of the third identification are represented by diamonds. A standard for collating the reported positions may be based on the time of the data. Thus, the plot of FIG. 3 shows a first times series of clusters for the first identification, shows a second times series of clusters for the second identification, and a third times series of clusters for the third identification.

Size of a time slot, referred to as tₛ, may depend on how fast an identification is moving. The reported positions may be clustered in a time slot where an identification traverses a specific distance (e.g., 6 inches). A motor vehicle will go slower in an urban environment (˜15-25 m/h) than on a freeway or rural highway (˜60-80 m/h); and a pedestrian will travel much slower (˜3-4 m/h) than a vehicle. To group data in time slots where the position of the identification doesn't adversely affect the uncertainty, the distance may be less than the uncertainty in reporting the position of the identification. A tₛ may be calculated from typical speed of the identification in view of its environment. For example, a motor vehicle in an urban environment may have a tₛ=0.1 seconds, whereas one on a highway may have a tₛ=0.05 seconds. A human powered bicycle may have a tₛ=0.2 seconds in an urban environment, and a tₛ=0.1 seconds in a rural environment. Pedestrians may have a tₛ=0.1 seconds. Road objects known to behave erratically (e.g., small children, skateboarders) may have even smaller tₛ than anticipated by speed to ensure that erratic behavior is captured.

The clusters are not limited to positions. Clusters may be formed from vehicle sensor data, such as outside temperature, moisture, slippery road conditions, time of day, driver engagement, lights on/off, and tire pressure. This data may accompany each identification and position data set, or it could be sent separately on a periodic basis. For example, the vehicle sensor data may be sent every few minutes.

The server system 100 includes an analysis module 130 that is configured to perform statistical analysis on the clusters of each identification. The statistical analysis may include replacing each cluster with a statistical model. Each statistical model represents a more accurate position value than those reported individually by the motor vehicles, since not all motor vehicles will measure and calculate the absolute positions accurately. Each statistical model may include a mean position and standard deviation from the mean position. If the vehicle measurement uncertainty is known, the standard deviation can be weighed by considering this information. If N vehicles report a position of an identification at a given time slot, then as the number N increases, the confidence in the mean position increases and the standard deviation decreases. These yield error bars that will feed into projections of future movements.

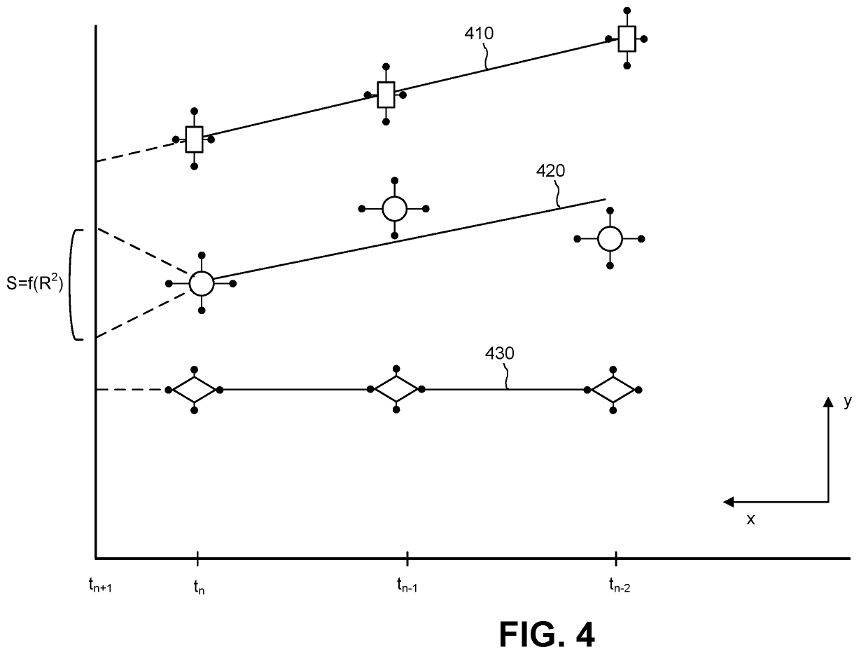

Additional reference is now made to FIG. 4, which illustrates statistical models, which replace the clusters of FIG. 3. Each geometric shape in FIG. 4 (rectangle, circle and diamond) represents a mean position, and the error bars represent standard deviations.

The server system 100 further includes prediction module 140 that is configured to perform prediction analysis on the time series of statistical models of each identification to predict future motion for each of the identifications. The predicted motion of an identification may include a predicted trajectory

FIG. 4 also shows trajectories 410, 420 and 430 denoted by solid lines and determined by a linear regression analysis of the statistical models of the identifications from tₙ₋₂ to tₙ. The linear regression analysis creates a best fit line representation of a trajectory based on the statistical models. The quality of the linear fit may be characterized by a Coefficient of Determination (R²), which is a measure of how well the trajectory fits the statistical models, or it may be characterized some other measure of “Goodness of Fit.”

Each trajectory 410, 420 and 430 may be projected to a future time (from tₙ to tₙ₊₁). In FIG. 4, each projection is represented by a dashed line or by a region of space that is bounded by dashed lines. The Goodness of Fit (e.g., the value of R² in FIG. 4) also indicates how well the projection will predict future positions.

The width of an area bounded by dashed lines may be at a minimum the width of the error bars. In FIG. 4, for behaviors where the R² value is high, the projected trajectory width increases with R², where the points lie further from the linear regression. As discussed below, more sophisticated models may be applied to obtain an improved fit, achieve a better Goodness of Fit, and increase the confidence in the predicted trajectory.

In the example of FIG. 4, the mean positions for the first identification are fitted to a first line indicating motion at a constant velocity. The R² value for this data set is low and the expected future behavior of the object has high confidence. The dotted line extends from the mean position at time tₙ and indicates predicted positions between time tₙ and time tₙ₊₁.

The mean positions of the second identification are also fitted to a second line However the R² value is large since two of the mean positions are not on the second line and are a significant distance from the second line. The predicted trajectories between to and tₙ₊₁ and, therefore, the possible positions at time tₙ₊₁ are represented by the area between the dotted lines, and the large R² value is reflected in the spread of the possible future positions. As illustrated in FIG. 4, the spread S is a function of the R² value. The large R² value indicates an erratic motion of the second nearby object. The spread S represents a locus of possible positions between times to and tₙ₊₁. Increasing the spread of a predicted trajectory has the effect of reducing the certainty of that predicted trajectory.

As for the third identification in FIG. 4, the mean positions are linear with a zero slope, and a very low R² value, which indicates no observable motion. The third identification might be fixed, or it might be mobile but at a standstill.

Although the use of R² values was just described to measure the “goodness of fit,” the prediction module 140 is not limited to R² values. Other measures may be used to evaluate the modeled trajectory fit to the data, such as Mean Square Error, Lack-of-fit sum of squares, Mallows cp criterion, Prediction error, and Reduced chi-square.

Although linear regression analysis was just described for trajectory prediction, the prediction module 140 is not limited to linear regression analysis. For example, polynomial fitting of the statistical models may be used. Polynomial regression can improve the predicted trajectory of an identification. A polynomial regression represents the independent variable (position) by an n^{th} degree polynomial as a function of the dependent variable (time). The greater the polynomial degree n, the greater the number of data points required to create an accurate fit.

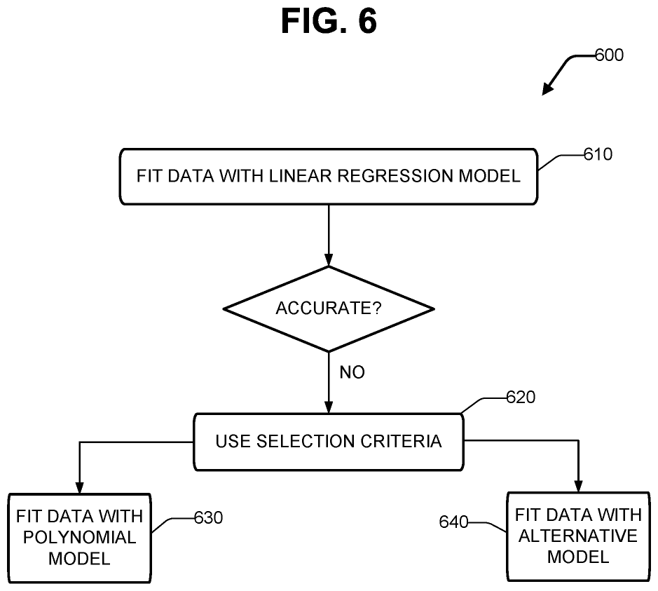

Reference is now made to FIG. 6, which illustrates an example of logic 600 for selecting different types of trajectory analysis for an identification. Initially, the prediction module 140 uses linear regression analysis (block 610) to predict a trajectory for a time series of statistical models. If Goodness of Fit of the linear regression analysis is not sufficiently accurate (e.g., R²>R²ₘₐₓ), a criterion is used (block 620) to select a higher order polynomial model (block 630) or an alternative model such as combining a sinusoidal movement with a linear movement (block 640). Such an alternative model would be better suited to analyze motion such as a mobile road object (e.g., a skateboard) weaving back and forth as it travels. Bayesian information criterion (BIC) or Schwarz information criterion (SIC, SBC, SBIC) may be used for model selection. Models with lower BIC are generally preferred.

The server system 100 includes a transmit module 150 for sending the predicted trajectories (e.g., locus of possible trajectories within a spread) to enhance their situational awareness of road objects on the road system. Data sent back to a recipient need not cover the entire road system. The predicted trajectories may be associated with only a relevant portion of a road system, such as within a radius of several blocks of the recipient. Additional information may be transmitted. The additional information may describe road objects along a navigation path.

The sending/receiving of the data structures and the sending/receiving of the predicted trajectories is not limited to any particular wireless technology. Wireless technologies may include xG (x=3,4,5, and any future versions) and/or WiFi or Bluetooth or any other wireless communication.

Recipients of the predicted trajectories may include motor vehicles, regardless of whether the motor vehicles have contributed data structures. The predicted trajectory information may be used by vehicle controls of autonomous control systems. Maps annotated with the predicted trajectory information could be displayed on heads up displays and touch screens.

Recipients are not limited to motor vehicles. A recipient may be any vehicle or any person who desires to have their situational awareness enhanced beyond their field of view. For example, the predicted information could be sent to train operators so they can monitor positions of vehicles and other road objects nearby train tracks. This information would provide the train operators with extra time to slow down or stop to avoid a collision with a road object on the tracks.

The predicted trajectories may be transmitted for public safety. For example, if an ambulance is approaching a motor vehicle from either behind or from a cross street, the server system 100 can inform that motor vehicle, which can then alert the driver or navigational system to move to the side or not to enter an intersection even if there is a green traffic light.

The predicted trajectories allow recipients to get insights about road objects that are not yet in its field of view. It also allows the motor vehicles to immediately assess road objects that suddenly appear into the field of view, even though that motor vehicle itself has not yet gathered sufficient information to perform for an assessment. In effect, the method allows the motor vehicles and other recipients to “see around the corner.”

The clustering and statistical modeling described above offer one approach towards aggregating the identifications and positions. An alternative approach towards aggregating is only to cluster the positions. Then, instead of performing trajectory analysis on the statistical models, trajectory analysis is performed directly on the positions.

Senders of the data structures are not limited to motor vehicles. For example, data structure may be sent by hardware on stationary infrastructure of the road system. For example, camera vision and/or LIDAR distancing systems may be mounted to traffic lights, stop signs, and overpasses of the road system. Additionally, private systems (e.g., Ring or CCTV systems) may be configured to contribute data structures. The hardware identifies road objects within its field of view and determines their absolute positions on the road system, and transmits this data to the server system 100.

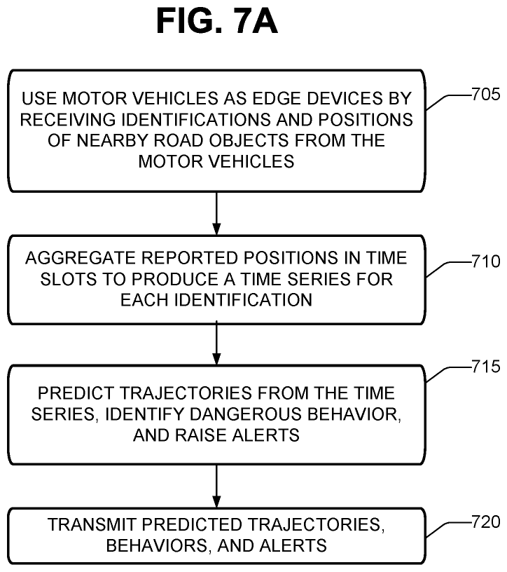

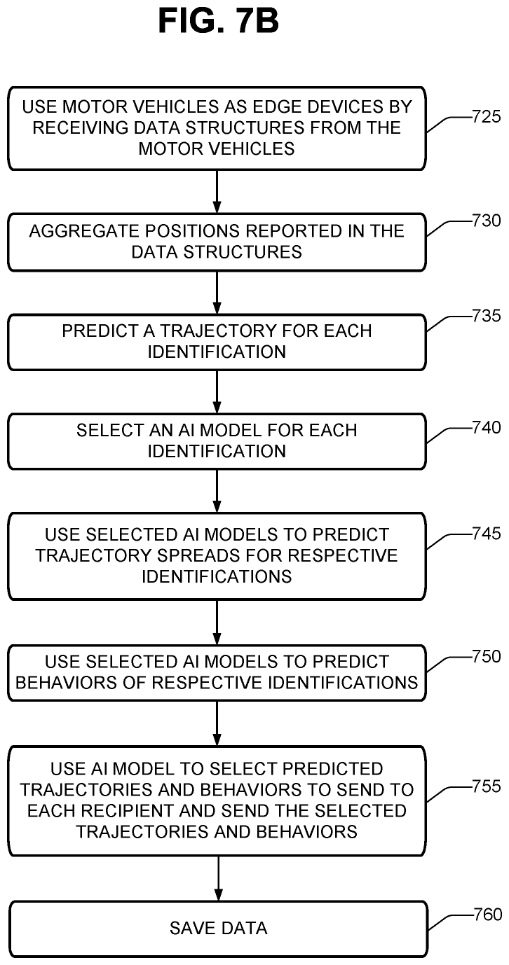

Additional reference is made to FIG. 7A which illustrates certain features of a method that may be performed by the server system 100. At block 705, the motor vehicles are used as network edge devices, and the server system 100 functions as a core computer. In general, edge computing includes edge devices that process data in real time near the data sources, and a core device that receives processed data from the edge devices and performs further processing. Since the edge devices are closer to the data sources, faster transmissions are possible. Further, some of the computational burden on the core device is offloaded to the edge devices.

Using the motor vehicles as network edge devices includes having the motor vehicles determine the identifications and positions of nearby road objects in real time while the motor vehicles are on a road system. The identification and the reported positions are transmitted to the server system 100. Additionally the motor vehicles may also perform some computing functions, such as further categorizing the identifications and calculating the velocities of the identifications. The categorizations and the velocities are also transmitted to the server system 100.

At block 710, the reported positions are aggregated. In some instances, the aggregation includes only forming clusters from the reported positions. A cluster is formed from all reported positions of an identification within a time slot. A cluster is formed within each time slot. As a result, each identification has a time series of clusters. In other instances (e.g., multiple edge devices reporting on the same object at substantially the same time), the aggregation includes forming clusters from the reported positions, and replacing the clusters with statistical models. As a result, each identification has a time series of statistical models.

At block 715, a trajectory is predicted for each identification from the corresponding time series. In some instances, only a single prediction model may be used. In other instances, an initial prediction model may be used, but a more advanced model is used instead if the Goodness of Fit is not acceptable.

At block 720, the predicted trajectories and any additional information are transmitted to recipients. The additional information may include classifications and velocities.

Using the motor vehicles as edge devices reduces latency and the processing burden on the server system 100. The edge devices perform basic computations such as identifying and categorizing nearby objects, measuring positions, and computing velocities. The server system 100 performs more complex computations, including the statistical analysis.

The prediction module 140 may perform further processing on the reported information and predicted trajectories to further enhancement situational awareness. Velocity of an identification may be reported in the data structures, or the velocity may be computed by the server system 100. The velocity may reveal dangerous behavior. As a first example, the server system 100 looks up a speed limit and compares the velocity to the speed limit. If the speed limit is exceed, the prediction module 140 raises an alert. As a second example, the server system 100 uses the reported geographic location and reported sensor information to determine road conditions. If the road conditions are poor (e.g., iced or wet roads) at night and the velocity is relatively high, the prediction module 140 raises an alert. As a third example, the classification of the identification is sufficiently detailed to look up (in a database) braking and handling capabilities of the identification. If the velocity exceeds the braking and handling capabilities of identification, the prediction module 140 raises an alert.

The prediction module 140 may be further configured to identify dangerous behavior characterized by the frequency of changes in reported velocity, where a high frequency of velocity changes is a more hazardous situation than a low frequency of velocity changes. Similarly, large changes in velocity may be considered more hazardous than small changes in velocity. A Fourier transform of the frequency of velocity changes of a nearby object may be performed. Peaks in the Fourier transform may be associated with different behaviors. For example, one peak may be associated with a vehicle drifting in the lane and correcting itself, and another peak may be associated with a vehicle weaving through lanes of traffic. Frequencies of velocity changes that are associated with hazardous behavior may be different for motor vehicles than for slower vehicles such as bicycles and skateboards.

With respect to FIG. 7A, the reported velocities may be received at block 705, the velocities and trajectories may also be analyzed at block 715, and alerts (if any) may also be raised at block 715. The velocities and alerts may also be transmitted by the transmit module 150 at block 720.

The enhanced situational awareness described above may be enhanced even further by the use of artificial intelligence (AI) models. As described in the following paragraphs, AI models may be used to modify trajectory predictions, and AI models may be used to identify a wider range of behaviors.

Reference is now made to FIG. 7B, which illustrates a method that uses AI models to further enhance situational awareness of road objects on a road system. At block 725, motor vehicles on a road system are used as edge devices, wherein data structures are received from the motor vehicles.

At block 730, the positions reported in the data structures are aggregated for each identification. As a result each identification has a corresponding time series of positions or statistical models.

At block 735, a trajectory prediction is made for each identification. Goodness of Fit of each predicted trajectory is determined. If the Goodness of Fit is not acceptable, a more advanced prediction may be made.

At block 740, an AI model is selected for each identification. The AI model may be selected from a collection of AI models. An AI model in the collection may be selected according to classification. For example, a first AI model in the collection may be selected to predict behavior of a pedestrian, a second AI model may selected to predict spread and behavior of a large road vehicle, a third AI model may be selected to predict spread and behavior of a small road vehicle, and so on. The collection may further include AI models corresponding to more detailed classifications. For instance, another AI model in the collection may be selected to predict spread and behavior of an aerial drone.

The AI models in a group may differ in terms of theory (e.g., linear regression, deep neural network), inputs, pre-processing of inputs, weights, etc. Greater accuracy and/or different types of behavior can be expanded though the use of detailed classifications, where the selected AI model also uses details associated with the identification to influence the model's weights.

At least some of the AI models in the classifications may be further differentiated according to environmental conditions, and may indicate how those environmental conditions affect the uncertainty of a prediction for that classification. For instance, a motorcycle operating in rain will have a greater spread than a motorcycle operating on dry road. The selected AI model may predict the behavior of a classification in an environmental conditions.

Data indicating environmental conditions may include sensor data reported in the data structures. Data indicating environmental conditions may also include information from weather reports (e.g., temperature, visibility). It could it also include time of day (which would reveal sunrise and sunset).

At block 745, for each identification, a selected AI model is used to create a spread of possible trajectories with time. For each identification, the selected AI model may process features such as points along the predicted trajectory, Goodness of Fit of the predicted trajectory, time of day, sensor data reported in the data structures, geographic location reported in the data structures, and historical data about the classification.

Historical data is classification-specific, and refers to past data about road objects in a particular classification. The historical data may also include environmental conditions of the road system at the time the other historical data was collected (e.g., temperature, presence of sun, rain, snow and fog), time of day (daytime, dusk, nighttime), location (e.g., urban and rural); and vehicle type. The historical data may also include statistics about performance in different environmental conditions.

As but one example, historical data reveals that bicycles on crowded city streets during business hours on sunny days are known to weave in and out of traffic. Say the trajectory prediction at block 735 indicates a trajectory having zero spread. However, the historical data adds a measure of uncertainty in the position of the bicycle at any given time. In view of the historical data, the selected AI model will add a spread to the predicted trajectory.

At block 750, a selected AI model predicts behavior of an identification. Inputs to the selected AI model may include, without limitation, points along the predicted trajectory, Goodness of Fit of the predicted trajectory, time of day, sensor data reported in the data structures, geographic location reported in the data structures, and historical data about the classification. In some instances, an output of the selected AI model may be a classification of a particular type of behavior. In other instances, an output of the selected AI model may also generate an alert as to the particular type of behavior.

For example, a selected AI model may recognize that certain types of automobiles have a greater frequency of velocity changes indicative of weaving between traffic lanes and raise an alert as to aggressive driving. A luxury car may have velocity changes indicative of drift and correction within a lane, and raise an alert about an inattentive driver.

At block 755, predicted trajectories and behaviors are selected for each recipient, and the selected trajectories and behaviors are transmitted to recipients. An AI model is used to select the predicted trajectories, behaviors, alerts and other information that will be transmitted to each recipient. The AI model is trained to identify probabilities of those recipients that will interact with a predicted trajectory or predicted behavior. Inputs to the AI model may include location of the recipient, whether recipient is in a vehicle or on foot, etc. Inputs may also include historical behaviors and current locations of nearby road objects, together with the expected movement of a recipient. If there is a non-negligible probability of interaction of the identification with a recipient, the predicted trajectories and behavior are transmitted to that recipient. The AI model may continue to evaluate the probability of interaction. If a probability exceeds a threshold probability, an alert may be issued to the recipient. If the identification is a user and also a recipient, an alert may be issued to the identification as well to prevent a possible collision or a dangerous situation.

If a recipient provides its navigation path to the server system 100, the AI model may consider probabilities of interacting with hazards along that navigation path. Alerts or recommendations for following a safter navigation path may be issued.

Selected trajectories, behaviors and other information may be transmitted to autonomous motor vehicles in a format that is usable by autonomous vehicle controls. An autonomous road vehicle having a level 4 classification may, for instance, may use a mapping service and the predicted trajectories and behaviors of the identifications to plot and execute a driving path along the road system.

Selected trajectories, behaviors and other information may be transmitted in a format for a display, such as a display on an automobile, a screen of a mobile phone, or the display of another mobile device. A mobile device may receive a map of the road system (e.g., from a mapping service), annotate the map with current positions, predicted trajectories and predicted behaviors of identification, add alerts, and transmit the annotated maps to recipients.

At block 760, sensor data, including environmental factors, and results of the AI models are saved. The saved data may be used to train and update the AI models in the collection.

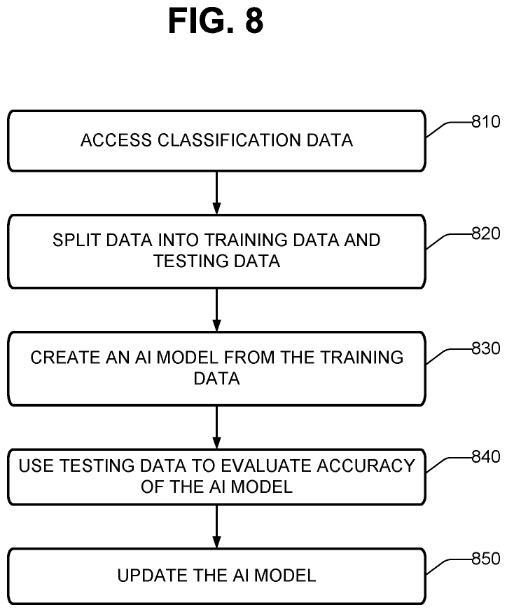

Reference is now made to FIG. 8, which illustrates a method of creating and updating an AI model in the collection. At block 810, historical data about a classification is accessed. The data may be related to similar objects in similar environments. At block 820, the data is split into training data and testing data.

At block 830, the AI model is created from the training data. Lasso and/or Ridge Regression may be used to constrain or regularize coefficients of the AI model. This may have the effect of shrinking certain coefficients towards zero.

At block 840, the testing data is used to evaluate the accuracy of the AI model. Once sufficiently accurate, the AI model is deployed to the collection.

As new objects are detected on the road system, new classification data, position data, sensor data, and predicted trajectory data are added as historical data to the database by the server system 100. At block 850, this saved data may be used for reinforced learning, in which the AI model is updated. For instance, Bayesian statistics may be used on the saved data to update the AI model. The updating may continue as more and more data is saved.

The functions of the server system 100 may be performed by one or more servers. As a first example, the server system 100 is configured as a single server system that is responsible for providing enhanced situational awareness to an entire road system. As a second example, the server system 100 is configured as a core server and multiple client servers, where each client server provides enhanced situational awareness to an assigned portion of a road system.

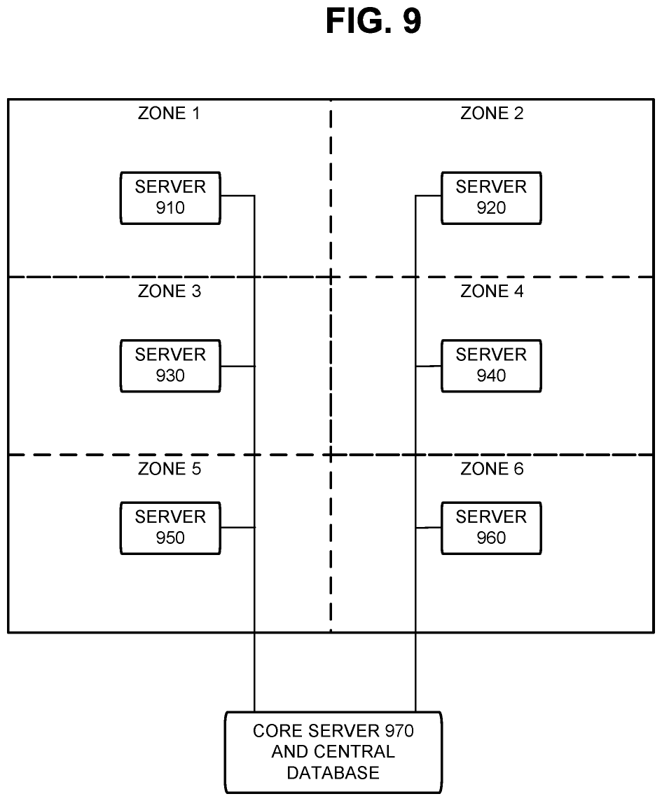

Reference is made to FIG. 9, which illustrates a server system 100 configured as six client servers 910-960 and a core server 970 having a central database. A first client server 910 is assigned to a first zone, a second client server 920 is assigned to a second zone, a third client server 930 to a third zone, a fourth client server 940 to a fourth zone, a fifth client server 950 to a fifth zone, and a sixth client server 960 to a sixth zone. The client servers 910-960 and the core server 970 may communicate via a wired network and/or wireless network. Boundaries of the zones may coincide for example, with the military grid reference system, with city limits, with county limits, with longitudinal and latitudinal coordinates, or with any other delineation format. If a motor vehicle passes from one zone to another zone, information for that motor vehicle may be handed off from one server to another.

In a variation, the zones can overlap. Consider the client servers 910 and 920 in zones 1 and 2. Both client servers 910 and 920 will be receiving information about a road object in an overlapping area. The overlap eliminates the handoff requirement and enables the movement from one zone to another to be seamless. Additionally, when a road object moves from zone 1 to zone 2, the client servers 910 and 920 from both zones will receive the same identification and reported positions data for the road object, and both client servers 910 and 920 transmit the data to the central database of the core server 970. The core server 970 recognizes that the reported positions of the road object are the same, which enables the trajectory and behavior of the road object to be tracked over time and space.

In another variation, the client servers 910-960 may transfer data to the database of the core server 970. The data may include mean positions of identifications, velocities of identifications, and sensor data. The core server 970 may maintain complete sets of data for all identifications over time and establish continuity of the movement of the identifications from one zone to another. The core server 970 may store this data in its database. All client servers 910-960 have access to the same data. As a result, no handoff between servers is needed.

The core server 970 may train the AI models on data sets that may be multimodal. Data sets may include tagged images of objects in various weather conditions, identifications reported in the data structures, positions reported in the data structures, timestamps corresponding to the reported positions, as well as movements of different objects in various weather and lighting conditions, etc. The positions may be represented as the statistical mean positions of an identification as reported by multiple vehicles. The movements may be velocities or accelerations reported in the data structures. Some of the tagged images may be generated by motor vehicles equipped with both camera vision and RF readers (the camera vision captures images, and the captured images are tagged with data received from wireless identification signals). As the clients severs 910-960 continually generate data and add to the data set, they transmit the data sets to the core server 970 for storage in the database (this corresponds to block 760 of FIG. 7B).

The core server 970 may use the data sets in the core server's database to train the AI models. The core server 970 may train each AI model in accordance with the method of FIG. 8. The core server 970 may transmit the trained AI models to the client servers 910-960.

Since data sets are continuously being generated, additional data will be stored after an AI model is trained. This additional data may be used to retrain and evolve the AI model to make the AI model more accurate. The core server 970 may transmit the updated AI model to the client servers 910-960.

The retraining may include reinforcement learning. Reinforcement learning may be implemented as the AI model(s) are deployed in the field to predict the trajectories and behaviors of new road objects in real time. Reinforcement learning may be conducted by having the AI models predict the trajectories and behaviors of road objects in real time, and comparing the actual trajectories and behaviors to the predictions by the AI models. Evaluating the accuracy of the predicted trajectories and behaviors reinforces a model's accuracy or inaccuracy and feeds back into the data and causes the weights of the AI model to be adjusted.

Moreover, the AI models may evolve in complexity. Once an AI model or set of AI models is trained, the performance is evaluated and hyperparameters (e.g., the number of layers, number of nodes, and values of the weights) may be optimized to optimize the performance of the AI model(s).

The core server 970 may perform other functions, such as performing trajectory prediction. For instance, a client server cannot predict a trajectory within an acceptable Goodness of Fi, so it requests the core server 970 to apply a more advanced prediction model. The client sever sends a time series of statistical models to the core server 970, and the core server 970 performs the more advanced trajectory prediction.

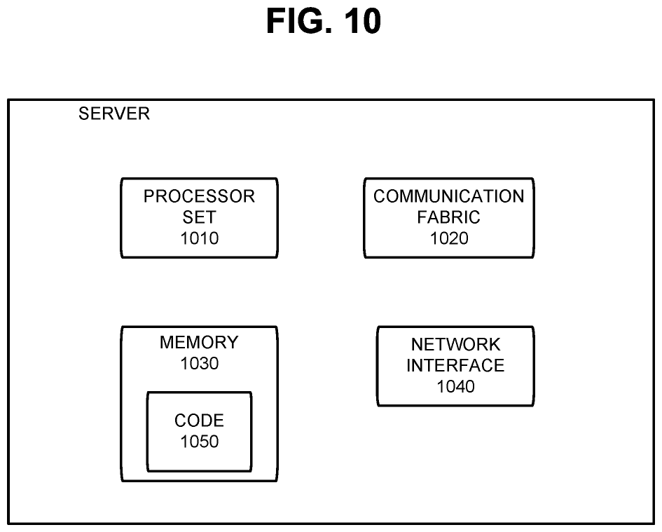

Reference is now made to FIG. 10. Each server 910-970 may include a processor set (i.e., one or more computer processors, including computing processing units and graphics processing units) 1010, communication fabric 1020, computer memory (volatile and persistent memory) 1030, and network interface 1040. The network interface 1040 may include software, hardware, and firmware that allows the servers 910-970 to communicate with each other, to receive data structures, and to transmit information to recipients. The computer memory 1030 is encoded with code 1050 that, when executed, causes the server to perform some or all of the functions described herein.

1. A computer-implemented method, comprising:
using a plurality of motor vehicles as network edge devices, including receiving data structures from the motor vehicles as the motor vehicles are on a road system, each data structure including a timestamp, at least one identification of a nearby road object, and a position of each identification;
aggregating a plurality of positions for each identification over time such that each identification has a corresponding time series; and
for each identification, predicting a trajectory from the corresponding time series.

2. The method of claim 1, wherein the aggregating includes:
creating clusters of positions for each identification over time, whereby each identification has a corresponding time series of clusters; and
replacing the clusters with statistical models, whereby each identification has corresponding time series of statistical models; and
wherein for each identification, the trajectory is predicted from the corresponding time series of statistical models.

3. The method of claim 2, wherein each statistical model includes a mean value of positions in the cluster it replaced.

4. The method of claim 1, further comprising transmitting at least one predicted trajectory to one or more recipients to enhance situational awareness of road objects on the road system.

5. The method of claim 1, wherein regression analysis is initially used to predict the trajectory of each identification.

6. The method of claim 5, wherein the regression analysis produces a predicted trajectory having a Goodness of Fit; and, if the Goodness of Fit is not sufficiently accurate, a more advanced analysis is used to produce a more accurate predicted trajectory.

7. The method of claim 1, wherein the predicting for each identification includes creating a spread of possible trajectories with time as a function of corresponding Goodness of Fit.

8. The method of claim 1, wherein the data structures further include velocities of the identifications and sensor data about road conditions; and wherein the predicting further includes determining whether an identification is traveling at an unsafe velocity in view of the road conditions, and raising an alert about the identification if the velocity is unsafe.

9. The method of claim 1, wherein the data structure further includes a classification of an identification; and wherein if the identification is classified as a motor vehicle having a model and make; the predicting further includes:
looking up braking and handling capabilities of the motor vehicle according to its model and make;
determining whether velocity of the motor vehicle is unsafe in view of its braking and handling capabilities; and
raising an alert about the identification if the velocity is unsafe.

10. The method of claim 1, wherein the predicting further includes computing a Fourier transform of frequency of velocity changes of that identification and associating peaks of the Fourier transform to identify dangerous behavior.

11. The method of claim 1, wherein the predicting for an identification having a classification includes using an AI model to create a spread of possible trajectories with time, the AI model trained to process a corresponding initial trajectory prediction and Goodness of Fit, sensor data reported in the data structures, and historical data concerning the classification.

12. The method of claim 1, wherein the predicting for an identification having a classification includes using an AI model to predict behavior of the identification based on an initial trajectory prediction, sensor data reported in the data structures, and historical data about the classification.

13. The method of claim 12, wherein the classification includes make/model of a vehicle; and wherein characteristics of the make/model are looked up and also used by the AI model to predict the behavior.

14. The method of claim 12, wherein the AI model used to predict the behavior is selected from a collection of AI models, where the selection is made according to classification.

15. The method of claim 1, further comprising using an AI model to select recipients of each predicted trajectory and each predicted behavior to enhance the recipients' situational awareness of relevant road objects on the road system.

16. The method of claim 1, further comprising sending the identifications and the predicted trajectories to motor vehicles in a format that is usable by autonomous vehicle controls.

17. The method of claim 1, further comprising sending the predicted trajectories to motor vehicles on the road system, including sending a map of the road system, wherein the map is annotated with the predicted trajectories of the identifications.

18. A server system for edge computing, the server system comprising at least one server configured with:
a first module configured to receive data structures from a plurality of motor vehicles as the motor vehicles are on a road system, each data structure including a timestamp, at least one identification of a nearby road object, and a position of each identification;
a second module configured to create clusters of positions for each identification over time, whereby each identification is associated with a time series of clusters;
a third module configured to replace the clusters with statistical models, whereby each identification is associated with a time series of statistical models; and
a fourth module configured to, for each identification, predict a trajectory from the time series of statistical models.

19. The server system of claim 18, wherein the at least one server includes a core server and plurality of client servers assigned to a corresponding plurality of zones of the road system; and wherein each client server includes first, second, third and fourth modules.

20. The server system of claim 19, wherein each server is configured to receive data structures from motor vehicles in its corresponding zone.

21. The server system of claim 19, wherein the core server is configured to store data sets from each client server and make the data sets accessible to all of the client servers.

22. The server system of claim 21, wherein the core sever is further configured to use the data sets to train and update AI models for predicting trajectories and behavior of road objects on the road system.

23. An article comprising computer memory configured with machine-readable code that, when executed, causes a processor set to:
receive data structures from a plurality of motor vehicles as the motor vehicles are on a road system, each data structure including a timestamp, at least one identification of a nearby road object, and a position of each identification;
create clusters of positions for each identification over time, whereby each identification is associated with a time series of clusters;
replace the clusters with statistical models, whereby each identification is associated with a time series of statistical models; and
for each identification, predict a trajectory from the time series of statistical models.
